(19) United States
(12) Patent Application Publication
(10) Pub. No.: US 2009/0003649 A1
(43) Pub. Date: Jan. 1, 2009

(54) IMAGE PROCESSING APPARATUS AND METHOD FOR CONTROLLING THE SAME

(75) Inventor: Yuuki Wakabayashi, Nishitokyo-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/146,382

(22) Filed: Jun. 25, 2008

(30) Foreign Application Priority Data
Jun. 27, 2007 (JP) 2007-169353

(51) Int. Cl. G06K 9/00; G06K 9/34

(52) U.S. Cl. 382/100; 382/175

(57) ABSTRACT

In an image processing apparatus, monochrome image data is printed onto a sheet and a user makes a mark in the sheet in order to specify an area. The marked sheet is scanned by a scanner. The mark is extracted from data generated by scanning. Registration is performed based on coordinates of the scanned data and the monochrome data. Based on the result of the registration, the extracted mark is represented in original image data. Accordingly, a complicated area can be easily specified so that the user can make a mark by hand.

### BACKGROUND OF THE INVENTION

1. Field of the Invention

The present invention relates to an image processing apparatus to specify a specific area of image data and to a method for controlling the image processing apparatus.

2. Description of the Related Art

In recent years, people have had more opportunities to create New Year's cards by combining an image of a person with a plurality of pieces of image data including characters and illustrations. For example, when a user wants to extract a person from an image and combine it to other image data, he/she specifies a desired area of the image by using an image editing application or the like in a PC (personal computer) and then combines the image of the specified area with an image of characters or illustration. However, if the specified area includes a person, he/she needs to specify an area of complicated shape, which is inconvenient for the user.

For example, a mouse has been widely used as an input device in a PC, but it is difficult for a user to specify an accurate position and a complicated shape by using this input device.

A method for solving such a problem is disclosed in Japanese Patent No. 2859903, for example. According to this method, a user specifies a desired area with a pen by directly making a mark in a sheet on which an image is printed. Then, the marked sheet is read by an image reading apparatus. The area is specified in the read image.

Specifically, an original paper document is read and copied. At this time, the read original paper document is stored as image data in a memory.

Then, on the output copied document, the user directly specifies an area by hand with a color pen or the like. Then, the copied document on which the area is specified is read and the specified area is recognized. Based on the recognized area, image editing such as trimming is performed on the image data that was stored in the memory at copying and the edited image data is printed.

However, the above-described technique has the following disadvantages. Since the original document is a paper medium, the image data based on the specified area is generated based on a document that is made by once reading the original paper document and outputting the read data onto a paper medium. Accordingly, the image data in which the area is specified may be degraded compared to the original image data.

Furthermore, registration is difficult to perform when the specified area has a complicated shape of a person or the like or when a copied document is placed on an original platen while being inclined. In such a case, it is difficult to accurately represent the image data of the specified area in the original image.

### SUMMARY OF THE INVENTION

The present invention provides an image area specifying apparatus capable of accurately representing a complicated area specified on a document in an original image and a method for controlling the apparatus.

According to an embodiment of the present invention, an image processing apparatus capable of extracting a specified area from image data is provided. The image processing apparatus includes a first converting unit configured to convert image data in which an area is to be specified to monochrome data; a printing unit configured to print an image based on the monochrome data used to specify the area in the image data onto a sheet; a scanning unit configured to scan the sheet in which a mark is made; a generating unit configured to generate corresponding scanned data which specifies the area in the image data; an extracting unit configured to extract the mark based on color information from data generated through scanning by the scanning unit; a detecting unit configured to detect coordinates of the mark in the monochrome data based on coordinates of the monochrome data and the scanned data; and a control unit configured to perform control to represent the mark extracted by the extracting unit in the image data based on the coordinates of the mark detected by the detecting unit and the coordinates of the monochrome data.

With the above-described configuration, the following advantages can be obtained.

(1) An image based on a specified area can be extracted from original image data, and thus degradation in image quality can be prevented.
(2) An area specified through marking on a paper document by hand is read and registration between image data is performed before preparing a representation of the area of the original image data, so that the area desired by a user can be represented with high accuracy.

Further features of the present invention will become apparent from the following description of exemplary embodiments with reference to the attached drawings.

### BRIEF DESCRIPTION OF THE DRAWINGS

FIG. 1 is a block diagram of a configuration of an image area specifying apparatus according to a first embodiment of the present invention.

FIG. 2 is a flowchart illustrating an area specifying process according to the first embodiment of the present invention.

FIG. 3 illustrates scaling according to the first embodiment of the present invention.

FIGS. 4A and 4B illustrate luminance compression according to the first embodiment of the present invention.

FIGS. 5A and 5B illustrate examples of a document mark area according to the first embodiment of the present invention.

FIG. 6 illustrates auto cropping and inclination correction according to the first embodiment of the present invention.

FIGS. 7A and 7B illustrate a process of eliminating a document mark area from a target of measurement of difference values according to the first embodiment of the present invention.

FIGS. 8A and 8B illustrate coordinate transformation from the document mark area to second monochrome image data according to the first embodiment of the present invention.

FIGS. 9A to 9C illustrate examples of a mark line transforming method according to the first embodiment of the present invention.

FIG. 10 illustrates representation of a mark line in original image data according to the first embodiment of the present invention.

FIG. 11 is a flowchart illustrating an area specifying process according to a second embodiment of the present invention.

FIG. 12 schematically illustrates a process to printing out according to the second embodiment of the present invention.

FIG. 13 illustrates scaling according to the second embodiment of the present invention.

FIG. 14 illustrates coordinate transformation according to the second embodiment of the present invention.

FIG. 15 illustrates an application example of combining image data according to the present invention.

FIG. 16 illustrates an application example to an application of the present invention.

FIG. 17 illustrates an example of combining image data using the second embodiment of the present invention.

FIG. 18 illustrates an example of specifying a small area according to the first embodiment of the present invention.

FIG. 19 illustrates an example of specifying a small area according to the second embodiment of the present invention.

### DESCRIPTION OF THE EMBODIMENTS

### First Embodiment

An image area specifying apparatus having a printer function and a scanner function according to a first embodiment of the present invention is described next.

### <Configuration of MFP 100>

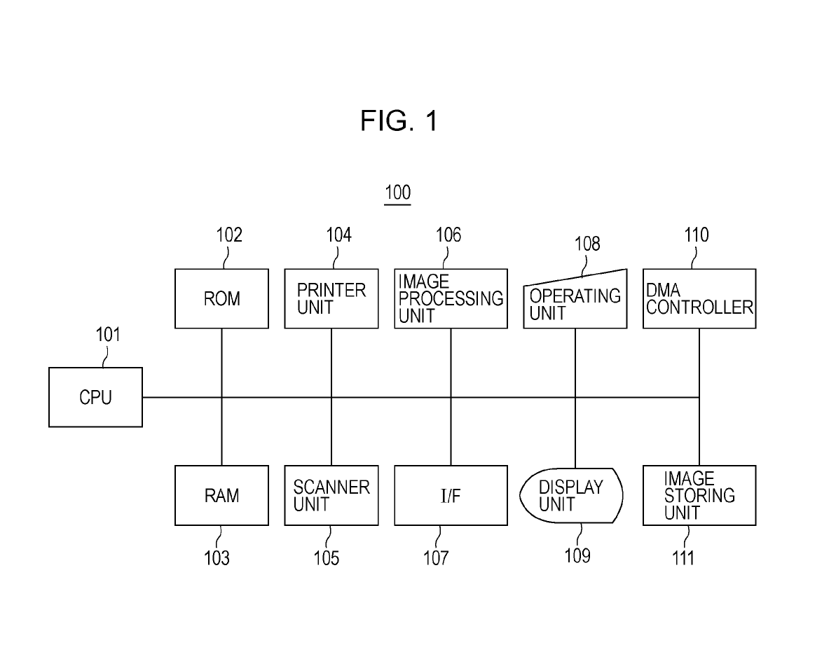

FIG. 1 is a block diagram of a configuration of a multifunction printer (MFP) 100, which is an example of the image area specifying apparatus according to the first embodiment of the present invention.

A CPU (central processing unit) 101 is a processor to control the entire MFP 100 and executes a program (firmware) stored in an ROM (read only memory) 102 in order to control the MFP 100. The ROM 102 is a nonvolatile memory to hold the program to control the MFP 100. A RAM (random access memory) 103 is a volatile memory used as a work area by the CPU 101 to execute the program stored in the ROM 102. The RAM 103 is used also as a buffer memory to temporarily store various image data.

A printer unit 104 prints image data onto paper, an OHP (overhead projector) sheet, or the like (hereinafter referred to as a printing medium). In this embodiment, an inkjet printer is used as the printer unit 104. For example, such inkjet printer may be formed in conventional manner using a recording head, a motor, an ink cartridge, and other well known components. The printer unit 104 performs printing by allowing a carriage provided with the recording head to reciprocate on a printing medium while ejecting ink and conveying the printing medium in the direction vertical to the moving direction of the carriage.

The scanner unit 105 scans an original document, such as paper, a plastic sheet, or a film, and generates image data. The scanner unit 105 temporarily buffers image data generated through scanning in the RAM 103. The scanner unit 105 includes a scanner head having a scanning width corresponding to an entire width of a maximum scannable original document (e.g., an A4 sheet). In the scanner head, a plurality of CCDs (charge coupled devices) or CISs (contact image sensors) are aligned in the scanning width direction, and image data is obtained through electrical scanning by those CCDs. The scanner head is mechanically moved for scanning by the motor in the direction vertical to the alignment direction of the CCDs. An entire original document can be scanned by combining the electrical scanning and the mechanical scanning. The scanner unit 105 scans an original document and generates color image data.

The color image data is image data in which each of the color components of RGB (red, green, and blue) is represented by 8 bits (0 to 255). The number of bits used to represent each pixel can be freely set in the range of the ability of the CCDs or CISs.

An image processing unit 106 performs digital image processing, such as scaling and conversion to monochrome image data, on various image data.

An I/F 107 is an interface to allow the MPF 100 to communicate with various external apparatuses. Examples of the external apparatuses include a personal computer (PC), a hard disk, and a drive to read/write data from/on a storage medium, such as a memory card. The type of interface may be USB (universal serial bus) or IEEE 1394, for example.

An operating unit 108 is operated by a user to provide various instructions to the MFP 100. The instructions that can be provided include copy instructions to allow the printer unit 104 to perform printing based on image data generated from an original document scanned by the scanner unit 105. Instructions to set an image area selecting mode, which is a mode to select an area in an image described below are also included. The instructions can be provided to the MFP 100 also from a PC or the like via the I/F 107.

A display unit 109 is used to notify a user of various pieces of information and, for example, may be formed in conventional manner using an LCD (liquid crystal panel), an LED (light-emitting diode), and other well known components. The information provided to the user includes a status of the MFP 100 (e.g., printing or idling) and a setting menu of the MFP 100.

A DMA (direct memory access) controller 110 is a controller used for DMA transfer of data between the respective elements in the MFP 100.

An image storing unit 111 stores image data. In the first embodiment, a hard disk drive included in the MFP 100 serves as the image storing unit 111. However, in another embodiment, a storage medium such as a memory card may be used as the image storing unit 111.

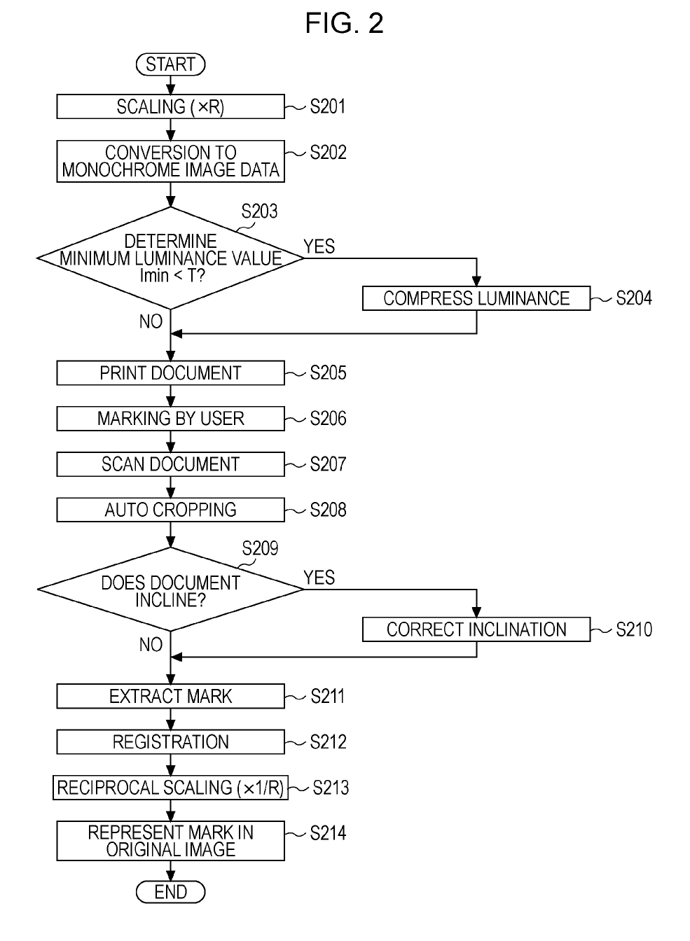

FIG. 2 is a flowchart illustrating an area specifying process according to the first embodiment. This process is performed in the image area selecting mode. The image area selecting mode is set upon acceptance of instructions from a user through the operating unit 108. In the image area selecting mode, the process is started upon acceptance of instructions to execute the process from the user.

### <Output of Marking Document>

First, original image data in which an area is to be specified is selected from the image data stored in the image storing unit 111 and is written in the RAM 103.

In step S201, the entire original image data is scaled to a size that can be fit within a sheet selected as a printing sheet in the MFP 100. In the first embodiment, the entire original image data is scaled to a maximum size that can be fit within the sheet. In another embodiment, the user can determine whether scaling should be performed or not through the operating unit 108. If scaling should be performed, the user can freely set a scaling factor R. The scaling factor R may be set to satisfy R<1, R>1, or R=1. In the first embodiment, the scaling factor R is set to satisfy R>1.

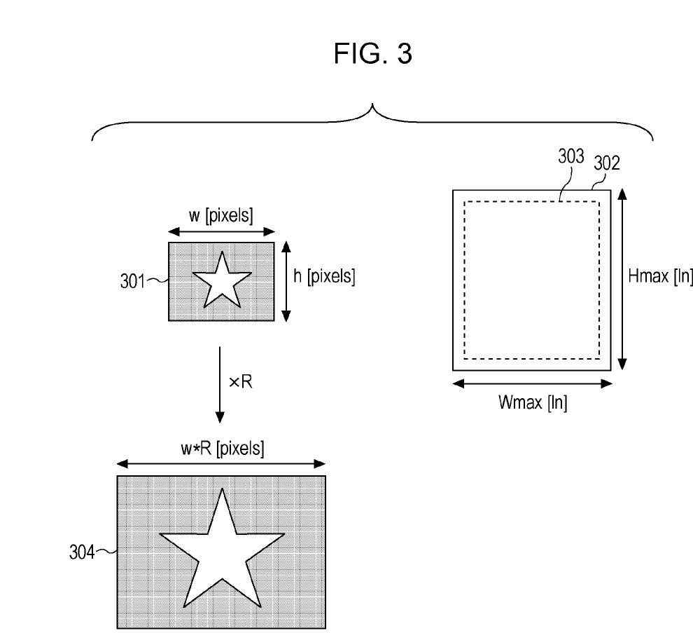

Reference is now made also to FIG. 3 which illustrates scaling according to the first embodiment. Here, the width of the original image data is w [pixels], the height of the original image data is h [pixels], the width of a printable area is Wmax [In], and the height of the printable area is Hmax [In]. In the first embodiment, w/Wmax>h/Hmax is satisfied. Before printed on a sheet 302 with N[dpi], the original image data 301 is scaled to a maximum size that can fit within a printable area 303. The scaling factor R is calculated by using expression (Ex. 1), and the original image data 301 is scaled with the calculated scaling factor R. Accordingly, scaled image data 304 is generated.

R=(Wmax×N)/w (Ex. 1)

Referring still also FIG. 2, in step S202, the scaled image data 304 is converted to monochrome image data. In the first embodiment, the scaled image data 304 is converted to gray-scale image data. The conversion is performed by setting the respective pixel values of RGB to “Gray” by using expression (Ex. 2).

Gray=(0.29891×R)+(0.58661×G)+(0.11448×B) (Ex. 2)

### Expression (2)

In another embodiment, the scaled image data 304 may be converted to magenta, red, or green image data. Hereinafter, the monochrome image data generated by converting the scaled image data 304 is called first monochrome image data.

In steps S203 to S204, luminance compression is performed as necessary on the first monochrome image data. The luminance compression is performed to enhance a mark detection rate when the monochrome image data is gray-scale image data. More particularly, in the gray-scale image data, a part having the smallest luminance value may be black, and thus without luminance compression the detection rate of a mark in that part might decrease or become zero disadvantageously. The luminance compression is performed to overcome such a disadvantage.

In step S203, a minimum luminance value lmin of the first monochrome image data is measured to determine the luminance. If the minimum luminance value lmin is smaller than a preset threshold T, that is, when lmin<T is satisfied (Yes in step S203), luminance compression is performed. In the luminance compression, the luminance of the first monochrome image data is compressed in a direction of higher luminance.

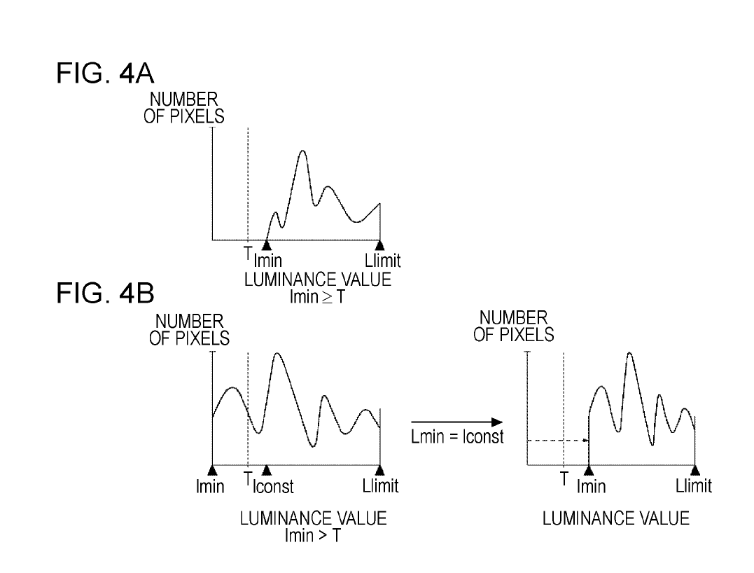

Reference is now made also to FIGS. 4A and 4B which illustrate luminance compression according to the first embodiment. In the graphs in FIGS. 4A and 4B, the horizontal axis indicates a luminance value, whereas the vertical axis indicates the number of pixels having each luminance value in the first monochrome image data. In FIG. 4A, lmin≧T is satisfied and thus luminance compression is not performed. In FIG. 4B, lmin<T is satisfied and thus luminance compression is performed. The luminance compression is performed based on expression (Ex. 3) by defining an upper limit of a luminance value in the image data as Llimit, an original luminance value in each pixel as l, a luminance value after compression in each pixel as L, and a minimum luminance value after compression as Lmin.

L=Llimit−(Llimit−l)×(Llimit−Lmin)/(Llimit−lmin) (Ex. 3)

In the first embodiment, the minimum luminance value after compression Lmin is a preset value lconst, as illustrated in FIG. 4B.

Referring still also to FIG. 2, luminance compression (at step S204) is performed as necessary (when determination is “Yes” in step S203) on the first monochrome image data converted to luminance values and then the compression result is reconverted to luminance values so as to generate second monochrome image data. If luminance compression is not performed (“No” in step S203), the first monochrome image data is regarded as second monochrome image data. The second monochrome image data is stored in the RAM 103.

In step S205, the second monochrome image data is printed out. An output resolution is set to N [dpi]. Hereinafter, the printed out document is called a marking document.

### <Marking>

In step S206, the user makes a mark with a pen directly in the marking document in order to specify an area. In the first embodiment, the color of mark is red, and the marked area is closed. However, the marked area need not always be a closed area. In another embodiment, the area to be specified may be filled in. A difference between a closed area and a filled-in area is described below.

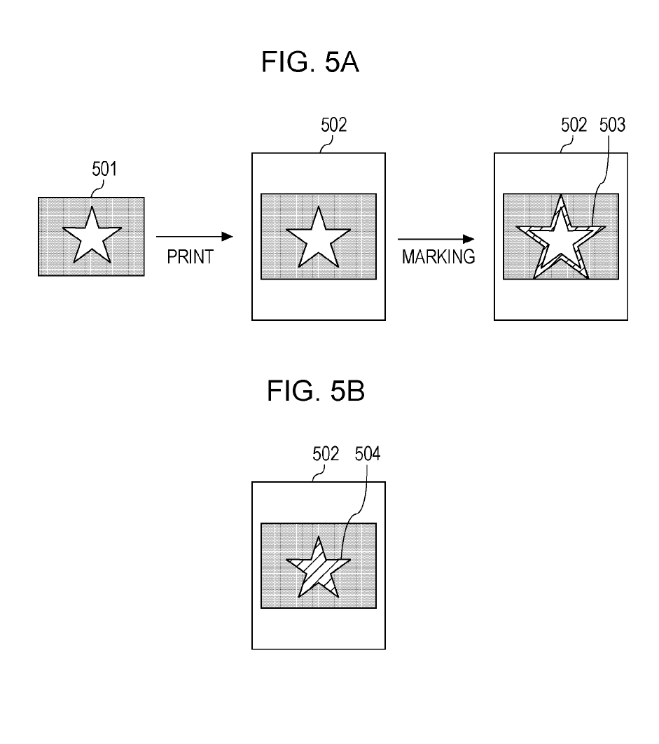

Reference is now made also to FIGS. 5A and 5B which illustrate an example of marking performed on the marking document. By printing second monochrome image data 501, a marking document 502 is generated. In the first embodiment, as illustrated in FIG. 5A as an example, the user makes a red mark in the marking document 502, so that a document mark area 503 is generated. The document mark area 503 is an area with diagonal lines, not a closed area surrounded by the mark. The document mark area 503 varies depending on the thickness of a pen used by the user.

As illustrated in FIG. 5B, a filled-in document mark area 504 may be made in the marking document 502 in another embodiment.

In the first embodiment, marking to specify an area is performed by using a red pen. However, the type of pen is not specified. Any color of pen may be used, including black, as long as the color is different from that of the marking document and the color has luminance density of a predetermined level or more.

### <Extraction and Representation of Mark>

Referring still also to FIG. 2, in steps S207 to S210, the marking document 502 is scanned, and then inclination is corrected and the specified area in the original document is extracted.

In step S207, the marking document 502 in which the document mark area 503 has been generated is scanned by the scanner unit 105. A reading resolution is N [dpi], which is equivalent to the output resolution used in step S205.

In step S208, auto cropping is performed on the image data corresponding to the scanned original document. In the auto cropping, the area of the placed document is extracted from the image data corresponding to the scanned original document. Accordingly, the document area is extracted by auto cropping.

In steps S209 to S210, inclination correction is performed on the document area. In particular, step S209 determines whether the document is inclined, and if so (“Yes” in S209), then the incline is corrected at step S210 to yield data of the document area that is then forwarded to step S211, whereas if not (“No” in S209), then data of the document area in step S209 is forwarded directly to S211. Steps S209 to S210 are collectively referred to as inclination correction. The data of the document area that has been extracted and on which inclination correction has been performed is called “marked document image data”.

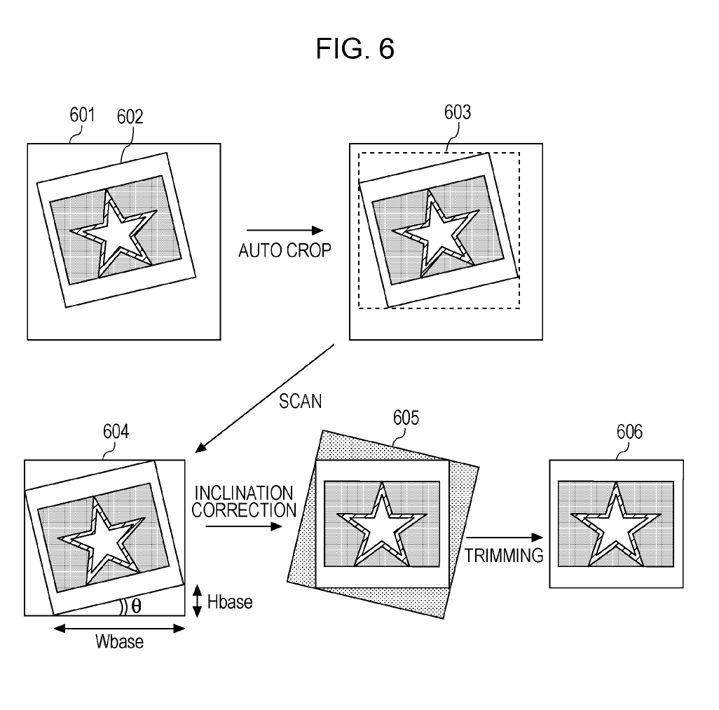

Reference is now made also to FIG. 6 which illustrates a flow of auto cropping and inclination correction in the first embodiment. A result obtained by scanning the marking document 502 is scanned image data 601, and the area corresponding to the making document 502 placed with inclination on an original platen is a document area 602. By performing auto cropping on the scanned image data 601, the document area 602 is detected. Then, a rectangular area 603 circumscribing the detected document area 602 is recognized. Then, the rectangular area 603 is extracted and is regarded as rectangular image data 604, so that an inclination angle θ can be calculated based on Hbase and Wbase by using expression (Ex. 4). Then, angle-corrected data 605 is generated by correcting the angle θ, and an area except a dotted area is extracted from the angle-corrected data 605 in order to generate marked document image data 606, which is stored in the RAM 103. Detailed algorithms of the auto crop function and the inclination correcting function are well known and thus further the description about them is omitted.

θ=arctan(Hbase/Wbase) (Ex. 4)

The reason for performing auto cropping and inclination correction is as follows. Even if the marking document is accurately positioned on the original platen, the marking document may be inclined due to wind caused by closing a pressing plate. If the marking document is inclined, image data generated by scanning the marking document is of course inclined. Registration between data is described below, but without auto cropping and incline correction, the accuracy of registration between the original image data in the RAM 103 and scanned image data might decrease disadvantageously. The auto cropping and inclination correction are performed in order to avoid such a problem.

Referring still also to FIG. 2, in step S211, the document mark area 503 is extracted from the marked document image data 606. Extraction of the document mark area 503 is performed by extracting pixels having a color component not similar to the monochromatic color in the marked document image data 606. In the first embodiment, gray-scale is used as the monochromatic color, and thus the pixels having a color component that is not R=G=B in the marked document image data 606 correspond to the document mark area 503. In another embodiment, if the monochromatic color is red, the pixels having a predetermined value or more of a G component or a B component in the marked document image data correspond to the document mark area. Furthermore, if the monochromatic color is magenta in another embodiment, the pixels having a color value of a G component of predetermined luminance or more in the marked document image data correspond to the document mark area. The document mark area extracted from the marked document image data is stored in the RAM 103.

In step S212, registration between the second monochrome image data and the marked document image data 606 is performed. In the first embodiment, the output resolution is equal to the reading resolution (N [dpi]), and thus the scale of the both image data is the same. Image similarity between the both image data is used for registration. The sum of difference values is used to measure the image similarity. At this time, the document mark area in the marked document image data is eliminated from the target of measurement of difference values. The reason for elimination is as follows. The color of the document mark area (red in this embodiment) does not exist in the original monochrome image data. Thus, a difference value is generated in the part of the document mark area in the original monochrome image data and the marked document image data. As a result, the document mark area decreases the similarity in the part where high similarity can be obtained if the mark does not exist. Accordingly, reliability of the similarity decreases and thus the document mark area is eliminated from the target of measurement of difference values.

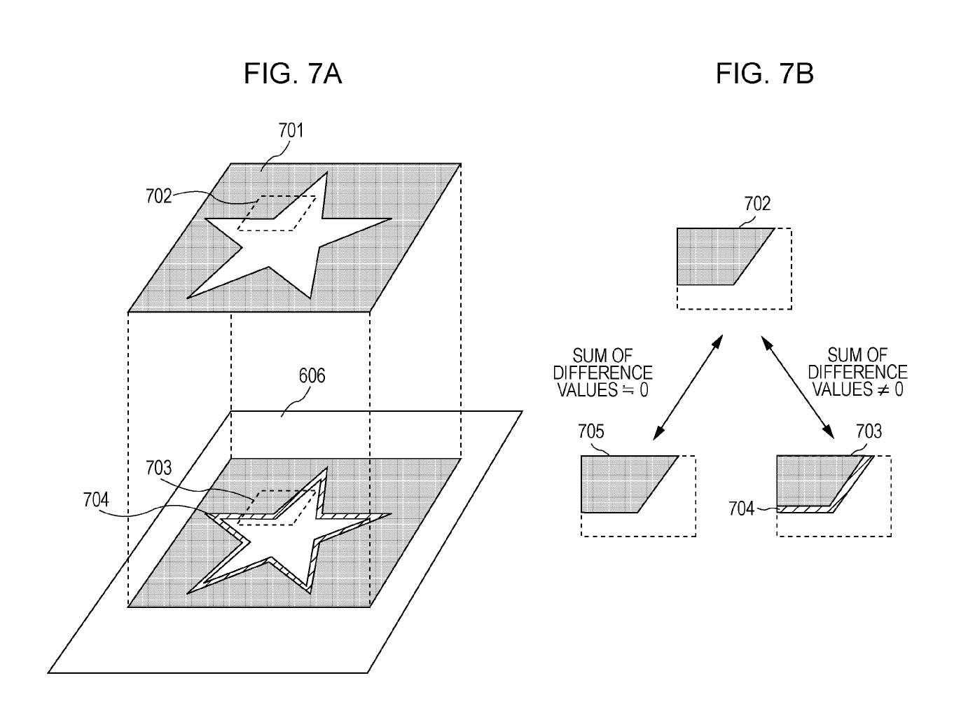

Reference is now made also to FIGS. 7A and 7B which illustrate a reason for eliminating a document mark area 704 from the target of measurement of difference values. FIG. 7A illustrates a position where the similarity between second monochrome image data 701 and the marked document image data 606 is originally the maximum. At this time, attention is focused on a small area 702 in the second monochrome image data 701 and a small area 703 in the marked document image data 606. FIG. 7B illustrates both small areas 702 and 703. A small area 705 is a small area in a case where marking is not made in the marking document. The sum of image difference values of the small areas 702 and 705 is approximate to zero. However, a difference value is generated at the position of the mark area 704 (also illustrated in FIG. 7A) in the small areas 702 and 703, and thus the sum of the difference values does not become approximate to zero. Accordingly, the position where the similarity should originally be the maximum can be unrecognizable. Therefore, in order to enhance the reliability of registration, the position of the mark area 704 is eliminated from the target of measurement of difference values.

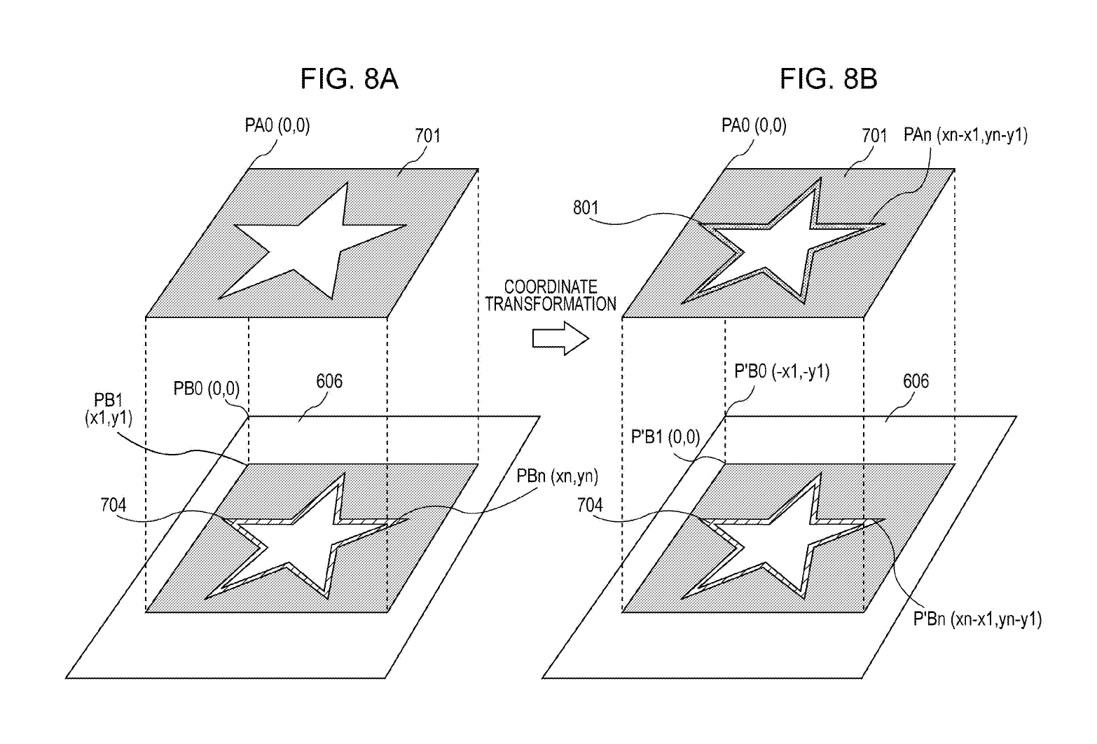

At the registration, the coordinate system of the document mark area 704 is transformed to the coordinate system of the second monochrome image data 701. FIGS. 8A and 8B illustrate the coordinate transformation. In the second monochrome image data 701, the origin is PA0 (0, 0). In the marked document image data 606, the origin is PB0 (0, 0), the point corresponding to PA0 (0, 0) is PB1 (x1, y1), and an arbitrary point on the document mark area 704 is PBn (xn, yn). The coordinates of the respective points on the marked document image data 606 are transformed in the following way through coordinate transformation. Assuming that the point PB1 (x1, y1) corresponding to the point PA0 (0, 0) is transformed to P′B1 (0, 0), the point PBn (xn, yn) is transformed to P′Bn (xn−x1, yn−y1). Accordingly, it can be understood that the point PAn (xn−x1, yn−y1) having the same coordinates as those of the point P′Bn (xn−x1, yn−y1) on the second monochrome image data 701 is a point in an area 801 corresponding to the document mark area 704. In this way, the mark area 801 in the monochrome image corresponding to the entire document mark area 704 can be recognized in the second monochrome image data 701. Under the coordinate transformation, the point corresponding to PB0 (0, 0) is P′B0 (−x1, −y1), as illustrated.

In the first embodiment, the document mark area 704 is represented in the second monochrome image data 701. However, the document mark area 704 may be transformed to the coordinate system on the scaled image data 304 in another embodiment. This is because, in coordinate transformation, not color information of the document mark area 704 but the position information thereof is required. The second monochrome image data 701 and the scaled image data 304 are different in color information but are equal in position information.

The mark area 801 in the monochrome image that has been transformed to the coordinate system of the second monochrome image data 701 is stored in the RAM 103.

In step S213 (FIG. 2), reciprocal scaling is performed on the mark area 801 in the monochrome image in order to transform it to the coordinate system of the original image data 301. Since the mark area 801 in the monochrome image is generated through scaling of the original image data 301 with the scaling factor R, the mark area 801 is multiplied by 1/R, which is a reciprocal of R. The area generated by multiplying the mark area 801 by 1/R is regarded as a mark area in the original image and is stored in the RAM 103.

Also, the mark area in the original image is transformed to a line (hereinafter referred to as a mark line). In the first embodiment, marking is performed by using a pen and thus the mark area in the original image has a width, but eventually the mark should be a line. There are a plurality of methods for transforming the mark area in the original image to a mark line. A difference in characteristic occurs depending on whether the mark is a closed area or a filled-in area, as described above.

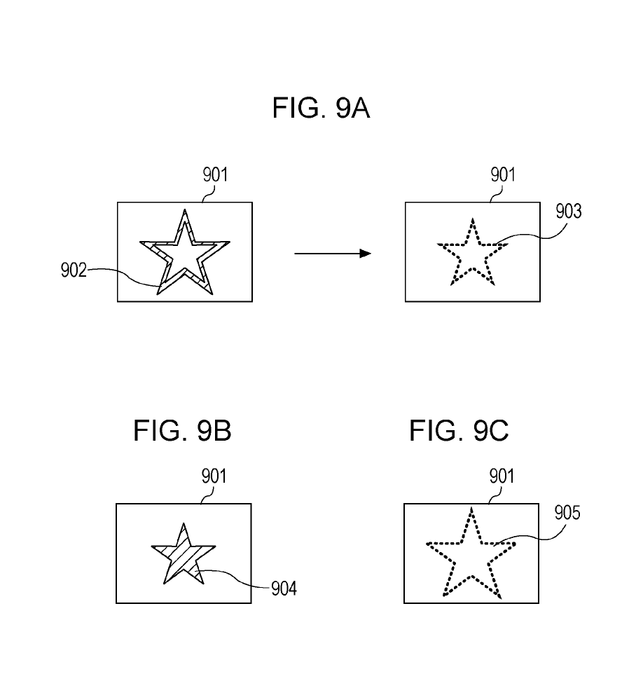

Reference is now made also to FIGS. 9A to 9C which illustrate an example of a mark line transforming method. FIG. 9A illustrates both a mark area 902 in the original image and a frame 901 of the coordinate system of the original image data 301. In the first embodiment, the inner line of the mark area 902 in the original image is regarded as a mark line 903. In another embodiment, if the filled-in mark as illustrated in FIG. 5B is made in step S206, a mark area 904 in the original image is filled in as illustrated in FIG. 9B. In that case, no inner line exists and thus the above-described method of regarding the inner line as a mark line is not used.

In another embodiment, an outer line of the mark area 902 in the original image may be regarded as a mark line 905, as illustrated in FIG. 9C. In this case, the mark may be any of a closed area and a filled-in area.

In step S214 (FIG. 2), the mark line 903 is represented in the original image data 301.

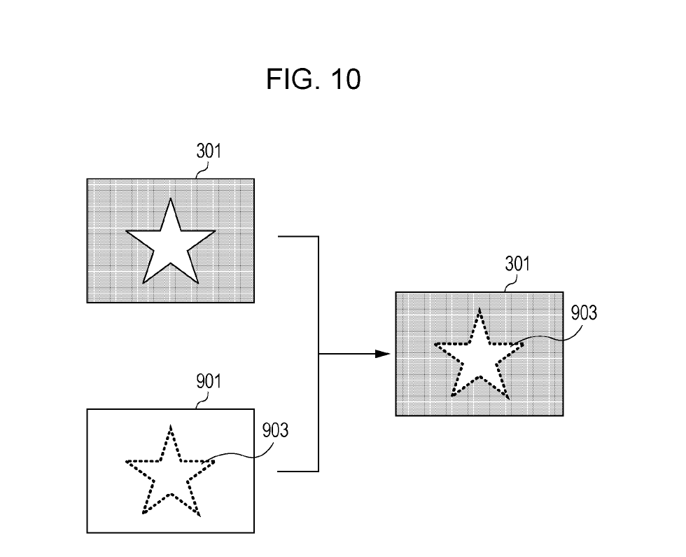

Reference is now made also to FIG. 10 which illustrates a process of representing the mark line 903 in the original image data 301. The mark line 903 and the original image data 301 have the same coordinate system due to steps S212 and S213, and thus the coordinates of the mark line 903 are thereby represented in the original image data 301. The frame 901 is also shown.

An application example of a specified area after the representation is described below.

### Second Embodiment

If the area which the user wants to manually specify is small in the original image data, it is difficult to specify the area in the first embodiment.

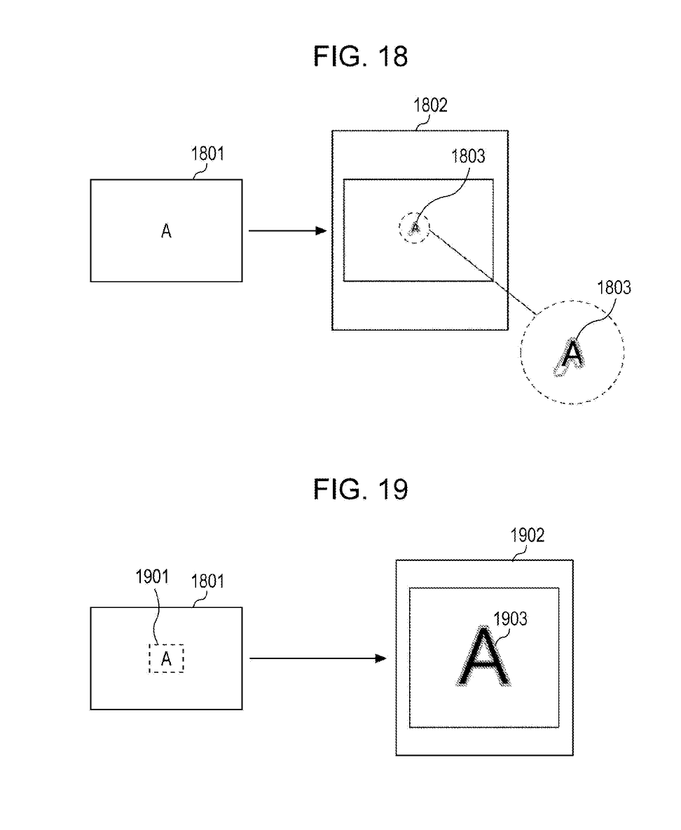

As illustrated in FIG. 18, if a character in original image data 1801 is small and if the user wants to specify the periphery of the character, it is difficult to manually make a mark in the area on a marking document 1802, which is generated by outputting the original image data 1801. As a result, a mark 1803 can be made.

In order to solve this problem, the area desired by the user is enlarged and then a marking document is printed. Reference is now made also to FIG. 19 which illustrates an example of specifying a small area. As illustrated in FIG. 19, the user specifies an area under a state where a specific area 1901 including the periphery of the character in the original image data 1801 is displayed in the display unit 109. The specific area 1901 specified by the user is enlarged and the image data is printed, so as to generate a marking document 1902. In the marking document 1902, marking can be performed to surround the character more easily than in the marking document 1802, so that an appropriate mark 1903 can be made.

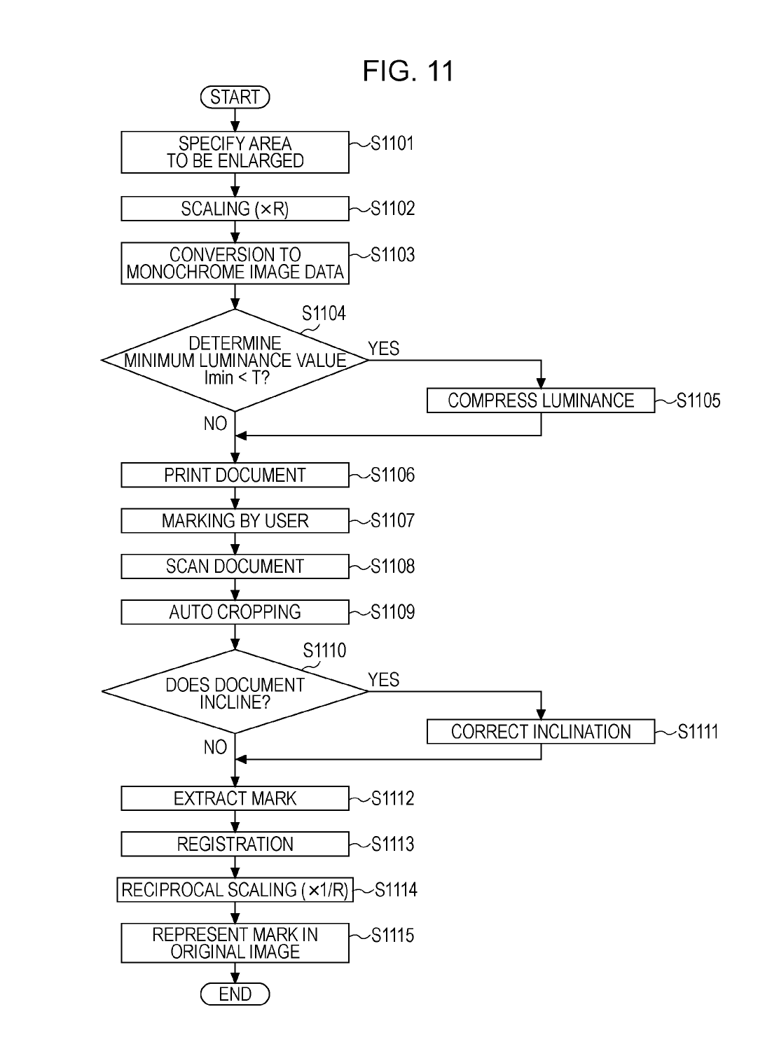

In the area specifying process, the user specifies an area to make a mark by hand through the operating unit 108 under a state where the original image data 301 stored in the RAM 103 is displayed in the display unit 109. Then, the specified area can be enlarged and printed. Reference is now made also to FIG. 11 which is a flowchart illustrating an area specifying process according to the second embodiment.

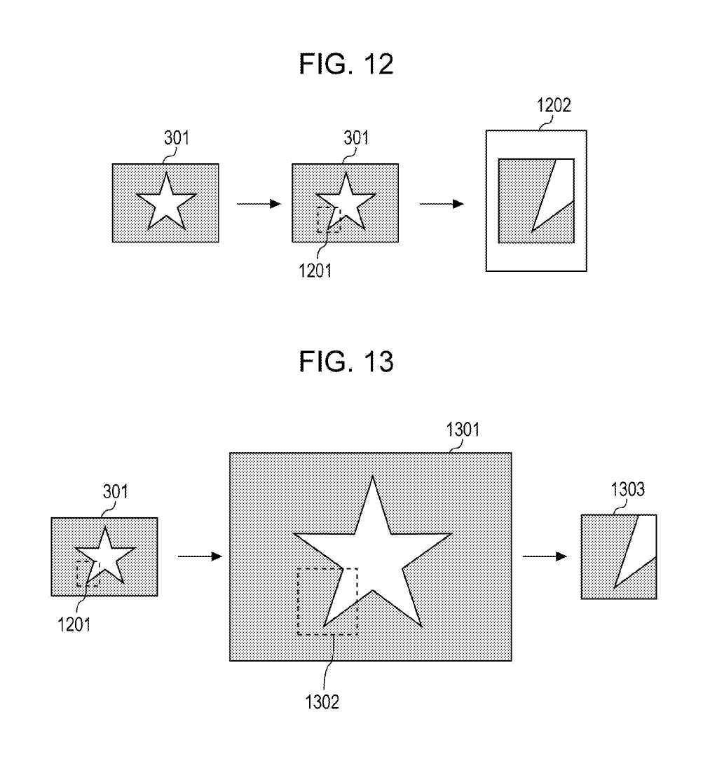

Reference is now made also to FIG. 12 which schematically illustrates a process performed until the image data is printed out according to the second embodiment. In the second embodiment, a rectangular area 1201 is a specific area. The user specifies the rectangular area 1201 in the original image data 301 through the operating unit 108. Step S1102 (FIG. 11) is performed on the original image data 301 and the rectangular area 1201. Steps S1103 to S1105 are performed on the rectangular area 1201. In step S1106, the rectangular area 1201 on which steps S1102 to S1105 have been performed is printed out as a marking document 1202.

Further details of the area specifying process according to the second embodiment are described next.

First, image data is written in the RAM 103 and is regarded as original image data 301.

Referring still also to FIG. 11, in step S1101, the user specifies the rectangular area 1201, in which the user wants to manually specify an area in the original image data 301, through the operating unit 108.

In step S1102, scaling is performed by setting an allowable maximum scaling factor so that the rectangular area 1201, not the entire original image data 301, fits within a sheet. As illustrated in FIG. 12, the rectangular area 1201 is enlarged and is printed out to generate the marking document 1202. Other than the setting of the scaling factor, the scaling according to the second embodiment is the same as that performed in step S201 in the first embodiment.

Reference is now made also to FIG. 13 which illustrates the scaling according to the second embodiment. The original image data 301 is scaled to generate first scaled image data 1301. Then, a scaled rectangular area 1302 corresponding to the rectangular area 1201 is extracted from the first scaled image data 1301 and is regarded as second scaled image data 1303.

Referring still also to FIG. 11, in steps S1103 to S1105, the same steps as steps S202 to S204 in the first embodiment are performed on the second scaled image data 1303 and the result is stored as second monochrome image data in the RAM 103.

In steps S1106 to S1112, the same steps as steps S205 to S211 in the first embodiment are performed.

In step S1113, registration between the marked document image data and the second monochrome image data is performed. As in the first embodiment, similarity based on the sum information of difference values between the marked document image data and the second monochrome image data is used for the registration. In accordance with the registration, coordinate transformation from the marked document image data to the second monochrome image data is performed, and then coordinate transformation from the second monochrome image data to the first scaled image data 1301 is performed.

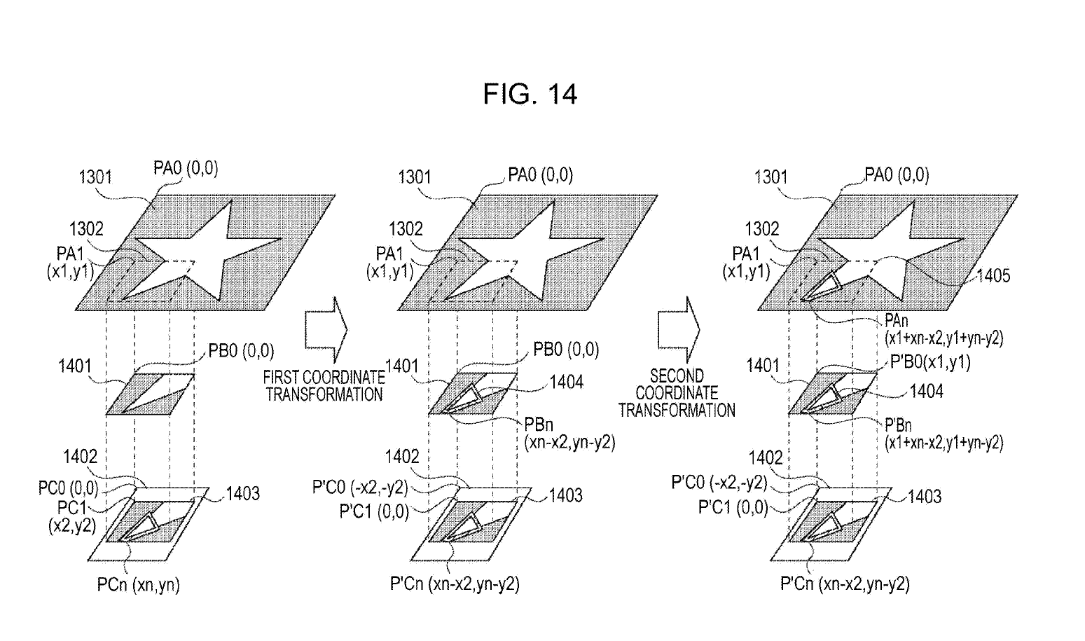

Reference is now made also to FIG. 14 which illustrates coordinate transformation according to the second embodiment. FIG. 14 is based on the assumption that registration based on the similarity between marked document image data 1402 and second monochrome image data 1401 has been completed.

The origin on the first scaled image data 1301 is PA0 (0, 0), and the reference point of the scaled rectangular area 1302 (the upper-left point in the area) is PA1 (x1, y1). The origin on the second monochrome image data 1401 is PB0 (0, 0). The origin on the marked document image data 1402 is PC0 (0, 0), the point corresponding to PB0 is PC1 (x2, y2), and a point in a document mark area 1403 is PCn (xn, yn).

By performing first coordinate transformation, the coordinates of the respective points on the marked document image data 1402 are transformed in the following way. Since PB0 corresponds to PC1, PC1 is transformed to P′C1 (0, 0), whereas PCn is transformed to P′Cn (xn−x2, yn−y2). Accordingly, PBn (xn−x2, yn−y2) is obtained. In this way, the entire document mark area 1403 can be represented as a mark area 1404 in the second monochrome image data 1401.

Then, by performing second coordinate transformation, the coordinates of the respective points on the second monochrome image data 1401 are transformed in the following way. Since PA1 corresponds to PB0, PB0 is transformed to P′B0 (x1, y1), whereas PBn is transformed to P′Bn (x1+xn−x2, y1+yn−y2). Accordingly, PAn (x1+xn−x2, y1+yn−y2) is obtained. In this way, the entire mark area 1404 can be represented as a mark area 1405 in the first scaled image data 1301.

Referring still also to FIG. 11, in steps S1114 to S1115, the same steps as S213 to S214 in the first embodiment are performed.

According to the above-described first and second embodiments, the user makes a mark by hand directly on a marking document, the marking document is scanned, registration of a detected mark is performed, and the mark is represented in original image data. Accordingly, a complicated area can be specified with high accuracy. Furthermore, by enlarging part of the original image data before printing it, a small area can be easily specified.

According to the embodiments of the present invention, an area of a complicated shape, such as a person, in image data can be specified.

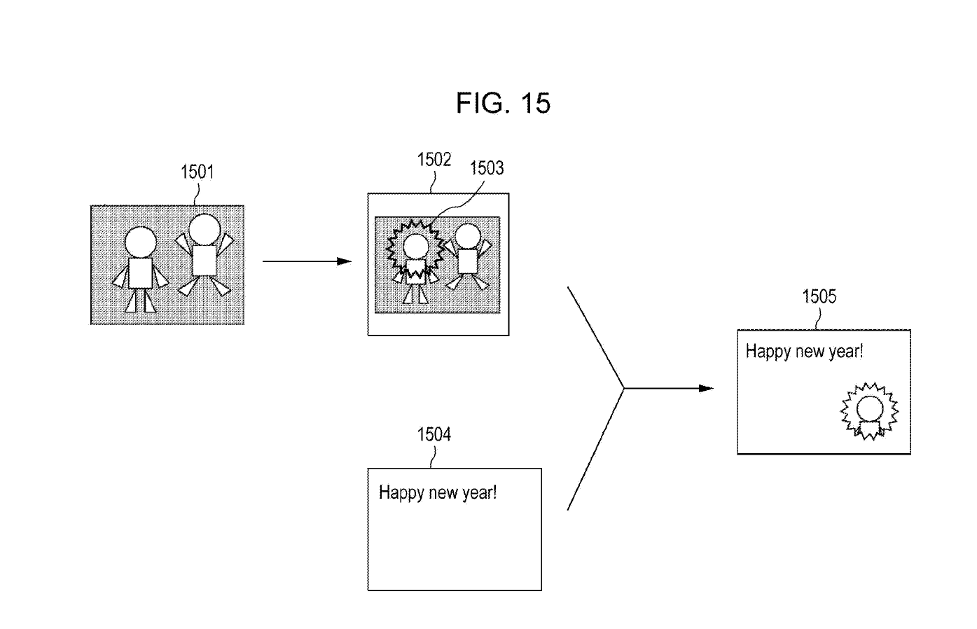

As an example, the present invention can be effectively applied when a person's photo is combined to a New Year's card. An example is illustrated in FIG. 15. In this case, a marking document 1502 is printed based on original image data 1501, and a mark 1503 is made. Then, the area specified by the mark 1503 is extracted from the original image data 1501 and is combined into image data 1504. Then, the composite image data is printed out, so that a composite document 1505 can be generated.

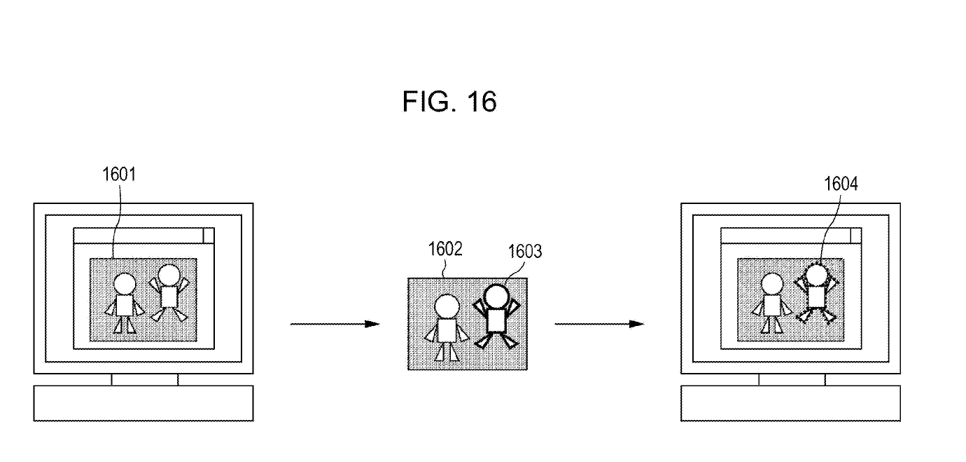

Alternatively, the present invention can be effectively applied to edit an image of a person in an image editing application in a PC, as illustrated in FIG. 16. In this case, a marking document 1602 is printed based on original image data 1601 so that a user can make a mark 1603. Then, the area specified with the mark 1603 by the user is represented as a selected area 1604 in the original image data 1601 in the image editing application in the PC.

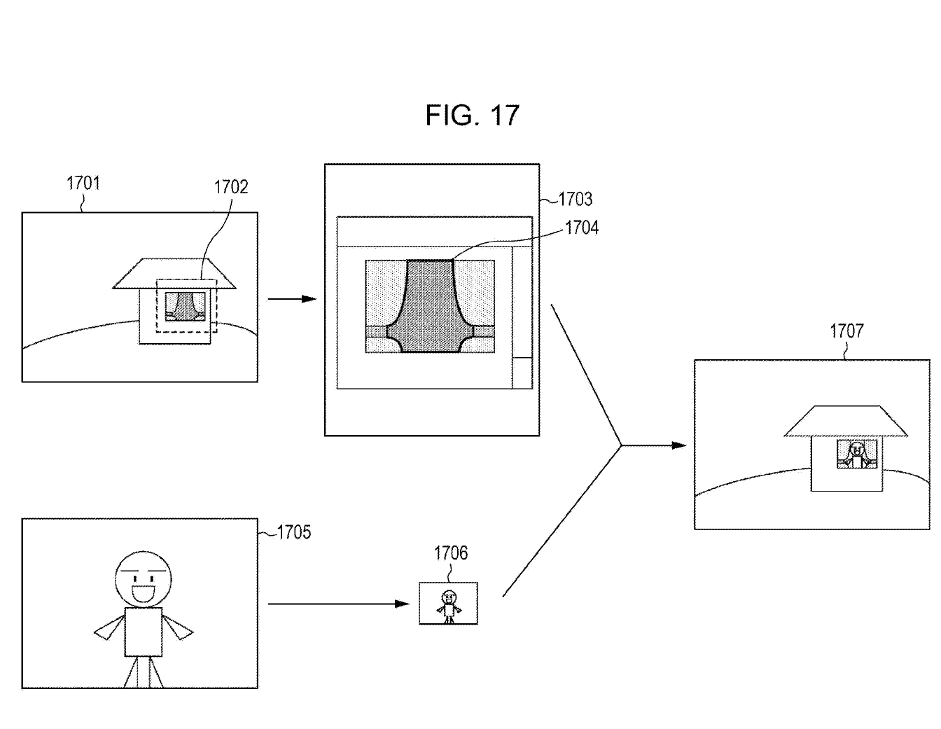

On the other hand, the second embodiment can be effectively applied to a case of extracting a small area of a scenery image or the like and embedding an image of a person in the extracted area. FIG. 17 illustrates an example of extracting part of original image data 1701 and embedding person image data 1705 in the extracted part. First, a specific area 1702 in the original image data 1701 is specified. A mark 1704 is made in a marking document 1703 in order to specify an area. The user scales down the person image data 1705 to an arbitrary size and generates scaled-down person image data 1706. The scaled-down person image data 1706 is embedded in the area specified with the mark 1704 in the original image data 1701, so that composite image data 1707 can be generated.

In the above-described embodiments, the image data stored in the MFP is used. However, the image data stored in a PC may be used. In that case, a specified area is represented in the image data stored in the PC.

In the above-described embodiments, determination of image similarity is used for registration. Alternatively, a marking document may be output after adding a mark for registration (not illustrated) to image data, and registration may be performed based on the mark. Specifically, the position of the mark for registration on the marking document is known, and thus registration is performed by recognizing the mark for registration in the read mark document image data.

Of course, both determination of image similarity and detection of the mark for registration may be used for registration.

In the above-described embodiments, original image data is output after being converted to monochrome image data. However, the conversion to monochrome image data need not be performed and color image data may be output as long as a mark can be detected.

In the above-described embodiments, the sum of difference values is used to determine image similarity. Alternatively, edge strength based on derivative values may be used.

In the above-described embodiments, the process is performed on original image data in the following order: scaling, conversion to monochrome image data, and luminance compression. However, this order can be changed without deviating from the scope of the present invention.

Also, the method for transforming coordinates, the method for compressing luminance, the method for extracting an image area from a document, the shape of a specific area, timing to specify the specific area, the method for transforming a mark area to a mark line, and a configuration of hardware are not limited to those described in the above-described embodiments.

The present invention can be carried out by storing software program code realizing the functions of the above-described embodiments in a storage medium. The storage medium is supplied to a system or an apparatus and a computer of the system or the apparatus executes the program code stored in the storage medium. Accordingly, the present invention can be achieved.

In that case, the program code read from the storage medium realizes the functions of the above-described embodiments, and thus the storage medium storing the program code constitutes the present invention.

Examples of the storage medium to supply the program code include a floppy disk, a hard disk, an optical disc, a magneto-optical disc, a CD-ROM (compact disc read only memory), a CD-R (compact disc recordable), a magnetic tape, a nonvolatile memory card, and a ROM (read only memory).

Furthermore, the functions of the above-described embodiments may be realized when an OS (operating system) operating in a computer performs part or all of actual processes based on instructions of the program code read by the computer.

While the present invention has been described with reference to exemplary embodiments, it is to be understood that the invention is not limited to the disclosed exemplary embodiments. The scope of the following claims is to be accorded the broadest interpretation so as to encompass all modifications and equivalent structures and functions.

This application claims the benefit of Japanese Patent Application No. 2007-169353 filed Jun. 27, 2007, which is hereby incorporated by reference herein in its entirety.

What is claimed is:

1. An image processing apparatus comprising:
a first converting unit configured to convert image data in which an area is to be specified to monochrome data;
a printing unit configured to print an image based on the monochrome data used to specify the area in the image data onto a sheet;
a scanning unit configured to scan the sheet in which a mark is made;
a generating unit configured to generate corresponding scanned data which specifies the area in the image data;
an extracting unit configured to extract the mark based on color information from data generated through scanning by the scanning unit;
a detecting unit configured to detect coordinates of the mark in the monochrome data based on coordinates of the monochrome data and the scanned data; and
a control unit configured to perform control to represent the mark extracted by the extracting unit in the image data based on the coordinates of the mark detected by the detecting unit and the coordinates of the monochrome data.

2. The image processing apparatus according to claim 1, further comprising:
a second converting unit configured to convert data of the area corresponding to the sheet scanned by the scanning unit to corrected data through inclination correction,
wherein the detecting unit detects a position of the mark based on the corrected data generated by the second converting unit.

3. The image processing apparatus according to claim 1, wherein the detecting unit detects a position of the mark based on similarity between the monochrome data and the scanned data.

4. The image processing apparatus according to claim 3, wherein the detecting unit detects the position of the mark based on similarity between the scanned data and the monochrome data from which the area of the mark is eliminated.

5. The image processing apparatus according to claim 1, wherein the first converting unit converts only an enlarged specific area in the image data to monochrome data.

6. A method for processing image data, the method comprising:
converting the image data in which an area is to be specified to monochrome data;
printing an image based on the monochrome data used to specify the area in the image data onto a sheet;
scanning the sheet in which a mark is made to specify the area in the image data;
extracting the mark based on color information from data generated through scanning;
detecting coordinates of the mark in the monochrome data based on coordinates of the monochrome data and the scanned data; and
performing control to represent the extracted mark in the image data based on the coordinates of the mark detected in the detecting step and the coordinates of the monochrome data.

7. The method according to claim 6, further comprising:
converting data of the area corresponding to the sheet into corrected data through inclination correction,
wherein the detecting detects a position of the mark based on the corrected data.

8. The method according to claim 6, wherein the detecting detects a position of the mark based on similarity between the monochrome data and the scanned data.

9. The method according to claim 8, wherein the detecting detects the position of the mark based on similarity between the scanned data and the monochrome data from which the area of the mark is eliminated.

10. The method according to claim 6, wherein the converting converts only an enlarged specific area in the image data to monochrome data.

11. A medium readable by a computer, the medium carrying a program of instructions for causing the computer to perform a method for processing image data, the method comprising:
converting the image data in which an area is to be specified to monochrome data;
printing an image based on the monochrome data used to specify the area in the image data onto a sheet;
scanning the sheet in which a mark is made to specify the area in the image data;
extracting the mark based on color information from data generated through scanning;
detecting coordinates of the mark in the monochrome data based on coordinates of the monochrome data and the scanned data; and
performing control to represent the extracted mark in the image data based on the coordinates of the mark detected in the detecting step and the coordinates of the monochrome data.

12. The medium readable by the computer according to claim 11, further comprising:
converting data of the area corresponding to the sheet into corrected data through inclination correction,
wherein the detecting detects a position of the mark based on the corrected data.

13. The medium readable by the computer according to claim 11, wherein the detecting detects a position of the mark based on similarity between the monochrome data and the scanned data.

14. The medium readable by the computer according to claim 13, wherein the detecting detects the position of the mark based on similarity between the scanned data and the monochrome data from which the area of the mark is eliminated.

15. The medium readable by the computer according to claim 11, wherein the converting converts only an enlarged specific area in the image data to monochrome data.
